(19) United States
(12) Patent Application Publication
(10) Pub. No.: US 2008/0150845 A1
(43) Pub. Date: Jun. 26, 2008

(54) DISPLAY DEVICE

(76) Inventors: Masato Ishii, Tokyo (JP); Naruhiko Kasai, Yokohama (JP); Mitsuhide Miyamoto, Kokubunji (JP); Tohru Kohno, Kokubunji (JP); Hajime Akimoto, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/874,961

(22) Filed: Oct. 19, 2007

(30) Foreign Application Priority Data
Oct. 20, 2006 (JP) 2006-286193

(51) Int. Cl. G09G 3/34

(52) U.S. Cl. 345/77

(57) ABSTRACT

A state of a deterioration (resistance change) of a display element is detected by a detecting unit through a switch and a detecting switch connected to a current source. On the basis of a detection result of the detecting unit, a display control unit corrects display data which is supplied to the display element.

### CLAIM OF PRIORITY

The present application claims priority from Japanese application serial no. 2006-286193 filed on Oct. 20, 2006, the content of which is hereby incorporated by reference into this application.

### BACKGROUND OF THE INVENTION

1. Field of the Invention

The invention relates to a display device which can control a luminance in accordance with an amount of current which is applied to a display element or a light emitting time. More particularly, the invention relates to a display device having spontaneous light emitting elements represented by organic EL (Electro Luminescence) or organic LEDs (Light Emitting Diodes) as display elements.

2. Description of the Related Art

Various display devices according to roles exist owing to the spread of various information processing apparatuses. Among them, the display device of the spontaneous light emitting type has been highlighted. Particularly, an attention is paid to an organic EL display. Since the light emitting elements such as organic EL, organic LED, and the like are of the spontaneous light emitting type, a back light which is necessary in a liquid crystal display (LCD) is unnecessary, so that such light emitting elements are suitable for realization of low electric power consumption. There are such advantages that a visibility of pixels and a response speed are higher than those of the LCD, and the like. Further, the light emitting element has characteristics similar to those of the diode and the luminance can be controlled according to an amount of current which is supplied to the element. A driving method in such a spontaneous light emitting type display device has been mentioned in U.S. Patent Laid-Open No. 2006/0139254A1.

### SUMMARY OF THE INVENTION

As characteristics of the light emitting element, an internal resistance value of the element changes depending on a using period or an ambient environment. Particularly, there is such a nature that when the using period becomes long, the internal resistance increases with the elapse of time and the current flowing in the element decreases. Therefore, for example, if the pixels at the same position in a display screen are continuously lit on as in the case of a menu display or the like, a Burn-in phenomenon occurs in such a light-on pixel portion. According to a correcting method in the related art, since the current is changed in accordance with characteristics of reference elements and a display area is uniformly corrected, it is impossible to cope with a variation in each display element.

It is an object of the invention to improve a partial deterioration such as a Burn-in or the like by detecting a state of each element and correcting without uniformly correcting a whole display area.

According to the invention, there is provided a display device comprising: a power source for detection which is independent of a power source for display; a switch for independently connecting the power source for detection and each of display elements; and a detecting unit for comparing voltages detected from the display elements, wherein display data which is inputted to each of the display elements is corrected on the basis of a detection result from the detecting unit.

According to the invention, reference elements arranged out of a valid display area which is used only in a detecting mode and each of the display elements arranged in the valid display area are sequentially compared. In a light emitting mode, the display elements are driven at a predetermined voltage. In the detecting mode, the reference elements and the display elements are driven by a predetermined current. As mentioned above, by using one current source for both the reference and the comparison upon detection, an influence by a variation in current source is eliminated and detecting precision is improved.

If the current which is supplied to the display element is made constant, a voltage across the display element rises in association with a deterioration in element. Therefore, by sequentially detecting states of the display elements, comparing the voltages of the display elements, and correcting a difference between the voltages, uniformity of the whole display area can be realized. In such a case, the reference elements are unnecessary.

According to the invention, the partial deterioration such as a Burn-in or the like can be improved. According to an embodiment 1 of the invention, the Burn-in phenomenon in the spontaneous light emitting display can be eliminated. According to an embodiment 2, a detecting time can be further shortened as compared with that in the embodiment 1. According to embodiments 3 and 4, since the reference elements are unnecessary, a construction can be simplified. According to embodiments 3 to 7, since there are a plurality of power sources for detection, a holding unit which is used in the embodiment 1 is unnecessary, so that the construction can be simplified.

The invention can be used as a display device sole body, a built-in panel, or a display device of an information processing terminal.

### BRIEF DESCRIPTION OF THE DRAWINGS

FIG. 1 is a whole constructional diagram;

FIG. 2 is a detailed constructional diagram of FIG. 1;

FIG. 3 is a diagram showing a displaying mode;

FIG. 4 is a diagram showing a detecting mode;

FIG. 5 is a constructional diagram of a reference element and display elements in an embodiment 1;

FIG. 6 is a constructional diagram of a detecting unit;

FIG. 7 is a diagram showing an operating period;

FIG. 8 is a flowchart of a display control unit;

FIG. 9 is a constructional diagram of reference elements and display elements in an embodiment 2;

FIG. 10 is a constructional diagram of display elements in an embodiment 3;

FIG. 11 is a constructional diagram of display elements in an embodiment 4;

FIG. 12 is a constructional diagram of a reference element and display elements in an embodiment 5;

FIG. 13 is a constructional diagram of a reference element and display elements in an embodiment 6; and

FIG. 14 is a constructional diagram of a reference element and display elements in an embodiment 7.

### DETAILED DESCRIPTION OF THE EMBODIMENTS

### Embodiment 1

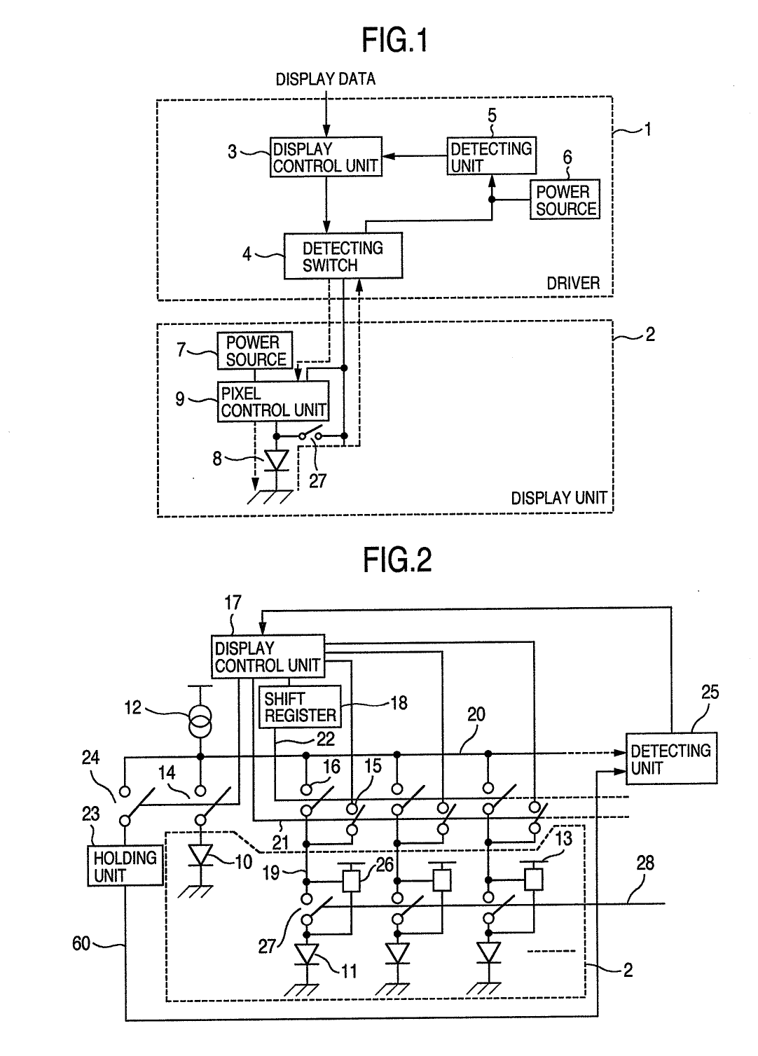

FIG. 1 is a whole constructional diagram in a display panel unit. The display panel unit is constructed by a driver 1 and a display unit 2. The driver 1 includes a display control unit 3, a detecting switch 4, a detecting unit 5, and a power source 6 for detection. The display unit 2 includes a power source 7 for display, a display element 8, and a pixel control unit 9.

In FIG. 1, display data from an outside is inputted to the display control unit 3 of the driver 1. The display control unit 3 makes timing control and signal control of the input display data. A signal flow in the driver 1 is mainly classified into the following three kinds of flow: a display path; a detection path; and a correction path.

The display path is a flow in which the input display data passes through the display control unit 3 and the detecting switch 4 in the driver 1 and enters the display unit 2 and the display element 8 is driven by the displaying power source 7 through the pixel control unit 9 in the display unit 2. The detection path is a flow in which the input display data is transmitted from the display element 8 in the display unit 2, passes through a switch 27, passes through the detecting switch 4 in the driver 1, and reaches the detecting unit 5. The correction path is a flow in which the input display data is transmitted from the detecting unit 5 in the driver 1 to the display control unit 3 and is corrected.

The detecting switch 4 switches the direction of the data in the displaying mode and the detecting mode. In the displaying mode, the displaying power source 7 is used as a power source of the display unit 2. In the detecting mode, the detecting power source 6 is used as a power source of the display unit 2.

Although the two power sources are used in the embodiment, the number of power sources can be increased or decreased according to a construction. As for power source types, a current source, a voltage source, and the like also vary according to the construction. In the displaying mode, the pixel control unit 9 controls the displaying power source 7 in accordance with the display data. In the detecting mode, the pixel control unit 9 notifies the detecting unit 5 of a state of the display element 8 by using the detecting power source 6.

FIG. 2 is a diagram showing an example of the whole constructional diagram shown in FIG. 1. The invention relates to a display device and will be explained with respect to an organic display device as an example of the display device. There are a reference element 10 and a display element 11 as pixels in the display device.

The reference element 10 is an element which is used only in the detecting mode and is used as a reference of detection and comparison in a state where a using frequency is reduced and a deterioration in element is suppressed. The display element 11 is an element which is always used in the driving mode. Upon detection, those two elements are compared and the state of the display element is obtained from a difference as a comparison result. A correction amount is calculated in a display control unit 17 on the basis of its result and is fed back to the display element 11.

Although the reference element 10 is provided in FIG. 2, the display element 11 can be also allocated to the reference element in accordance with a detecting construction. A driving power source of the display element 11 has an independent form in the detecting mode and the displaying mode. In the detecting mode, a current source 12 for detection is used. In the displaying mode, a voltage source 13 for display is used. It is preferable that the displaying voltage source 13 is used in common for the display elements which contribute to the display. The detecting current source 12 and the reference element 10 are connected by a switch 14. A switch 15 is turned on in the displaying mode. The detecting current source 12 and the display element 11 are connected by a switch 16. The switches 15 and 16 are not simultaneously turned on.

The display control unit 17 makes control of each switch and power source and makes detection and correction. A shift register 18 controls the switch 16. The shift register 18 can be built in the display control unit 17 or may be arranged as an independent control unit. The shift register 18 is controlled by the display control unit 17.

A signal line 19 is a common line which is used in both of the displaying mode and the detecting mode. The switches 15 connected to the signal line 19 are controlled by a control signal 21 which is controlled by the display control unit 17. The switch 16 is controlled by a control signal 22 which is controlled by the display control unit 17.

When the switch 14 and a switch 24 are ON, a holding unit 23 holds a voltage of the reference element 10 and outputs a voltage value as a reference voltage to a reference line 60. A detecting unit 25 compares data which is inputted from the reference line 60 with data which is inputted from a detection line 20 and outputs a comparison result to the display control unit 17. In this comparison, since the data is detected as a voltage, a comparator or the like can be used. It is also possible to construct in such a manner that when the comparison result indicates that a difference between the data is small, an amplifier is provided for the detecting unit, the detected voltage is amplified by the amplifier, and detecting precision is raised.

The displaying voltage source 13 and the display element 11 are connected by a pixel control unit 26. Although the power sources are separately provided like a detecting current source 12 and a displaying voltage source 13, they can be also unified to the power source of either the current source or the voltage source. The signal line 19 and the display element 11 are connected by the switch 27. The switch 27 is controlled by a mode selection signal 28 which is controlled by the display control unit 17.

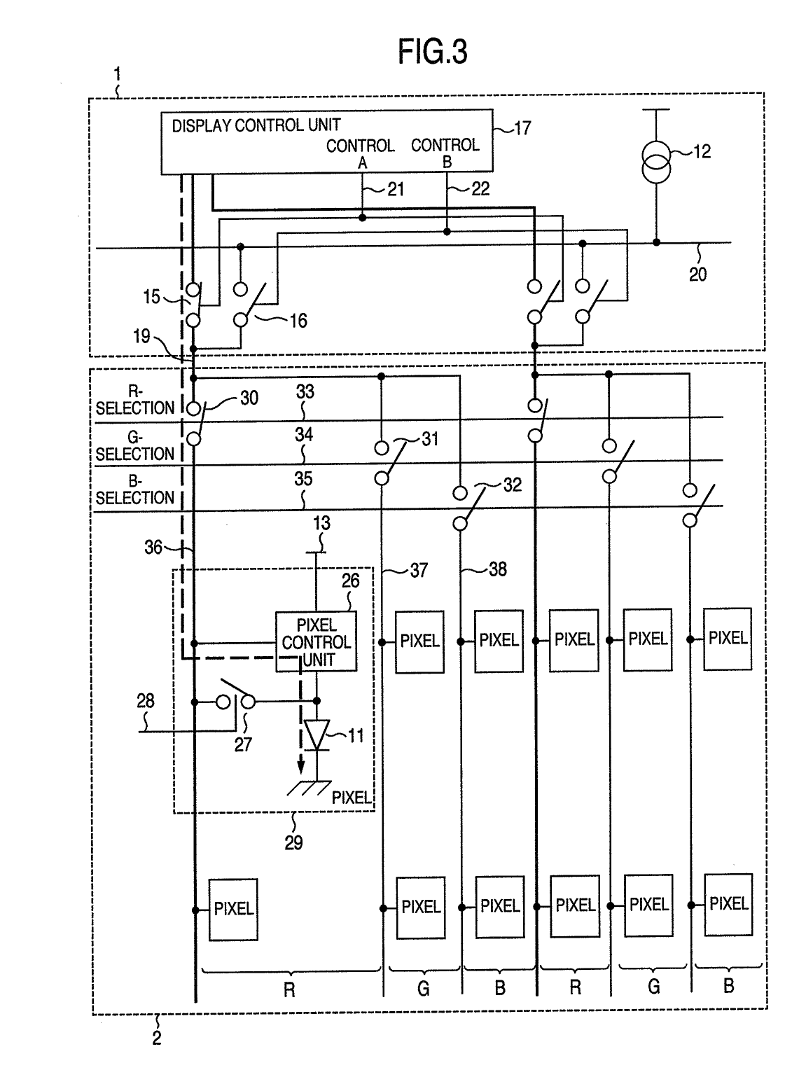

FIG. 3 is a constructional example showing further in detail a peripheral circuit around the signal line 19 in the construction of FIG. 2. A state in the displaying mode is shown. A pixel 29 is constructed by the display element 11, pixel control unit 26, and mode change-over switch 27. The mode change-over switch 27 is controlled by the mode selection signal 28. The switch 15 is controlled by the control signal 21 which is controlled by the display control unit 17. The switch 16 is controlled by the control signal 22 which is controlled by the display control unit 17.

In the embodiment, R, G, and B are time-divisionally controlled. The signal line 19 and pixels of R, G, and B are connected by an R-selecting switch 30, a G-selecting switch 31, and a B-selecting switch 32, respectively. The R-selecting switch 30 is controlled by an R-selection signal 33. The G-selecting switch 31 is controlled by a G-selection signal 34. The B-selecting switch 32 is controlled by a B-selection signal 35. Each pixel of R and the R-selecting switch 30 are connected by a signal line 36. Each pixel of G and the G-selecting switch 31 are connected by a signal line 37. Each pixel of B and the B-selecting switch 32 are connected by a signal line 38. The mode selection signal 28, R-selection signal 33, G-selection signal 34, and B-selection signal 35 can be controlled by the display control unit 17 or may be controlled by other independent circuits.

Subsequently, the operation of FIG. 3 will be described. In the displaying mode, the switch 15 is ON and the switch 16 is OFF by the control signals 21 and 22 which are supplied from the display control unit 17. In this state, the data from the display control unit 17 is supplied to the signal line 19.

In the displaying mode of R, in a state where the R-selecting switch 30, G-selecting switch 31, B-selecting switch 32, and mode change-over switch 27 which have time-divisionally been controlled are ON, OFF, OFF, and OFF, respectively, on the basis of the data from the display control unit 17, the pixel control unit 26 controls the voltage applied to the display element from the displaying voltage source 13 through a voltage line for display and applies the voltage to the display element 11 so as to emit light.

Similarly, in the displaying mode of G, in a state where the G-selecting switch 31, R-selecting switch 30, B-selecting switch 32, and mode change-over switch 27 which have time-divisionally been controlled are ON, OFF, OFF, and OFF, respectively, on the basis of the data from the display control unit 17, the pixel control unit 26 controls the voltage from the displaying voltage source 13 and applies the voltage to the display element 11 so as to emit the light.

Similarly, in the displaying mode of B, in a state where the B-selecting switch 32, R-selecting switch 30, G-selecting switch 31, and mode change-over switch 27 which have time-divisionally been controlled are ON, OFF, OFF, and OFF, respectively, on the basis of the data from the display control unit 17, the pixel control unit 26 controls the voltage from the displaying voltage source 13 and applies the voltage to the display element 11 so as to emit the light. In this manner, by controlling those switches, the display elements are sequentially allowed to perform the light emission.

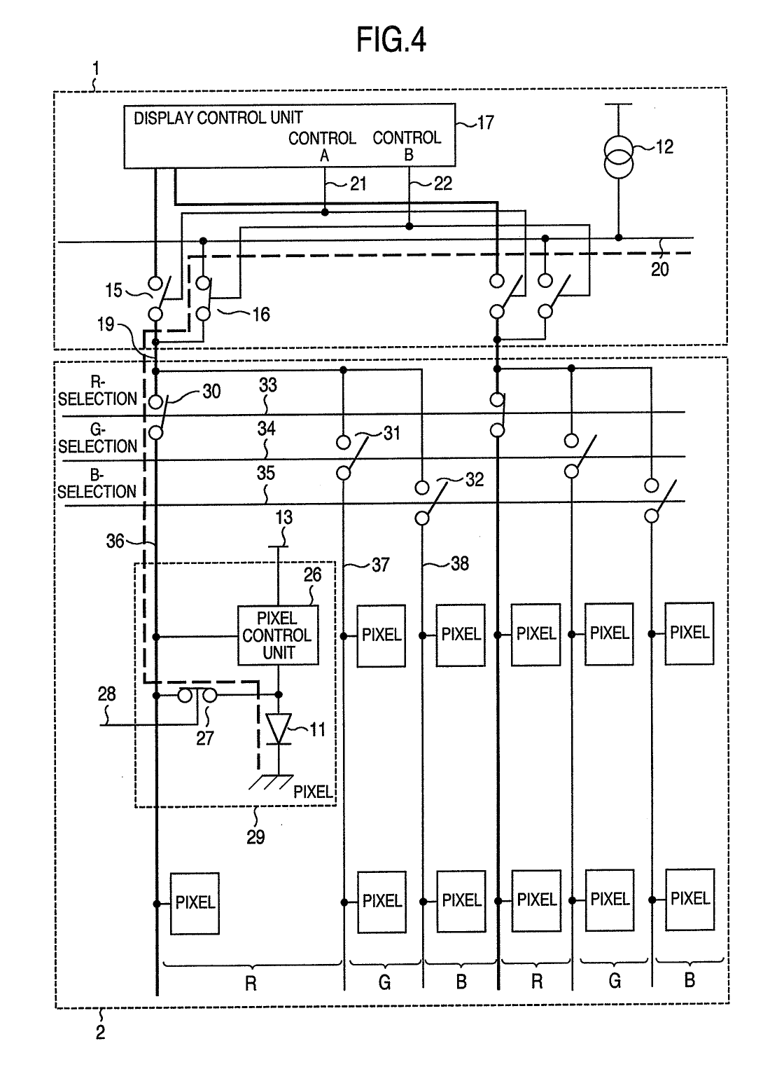

FIG. 4 shows the operation in the detecting mode in a construction similar to FIG. 3. In the detecting mode, the switch 15 is OFF and the switch 16 is ON by the control signals 21 and 22 from the display control unit 17. In this state, the signal line 19 is connected to the detection line 20. In the detecting mode, since it is necessary to read out the state of the display element 11, the pixel control unit 26 shuts off the voltage from the displaying voltage source 13. With respect to the pixel as a detection target, by turning on the mode change-over switch 27, the display element 11 is connected to the signal line 19.

To detect the pixel of R, the R-selecting switch 30 is turned on and the mode change-over switch 27 of the detection pixel is turned on. The detecting current source 12 is connected to the detection line. A predetermined voltage is developed on the signal line 19 depending on the characteristics of the display element 11 and the state of the display element 11 appears on the detection line 20.

Similarly, to detect the pixel of G, by turning on the G-selecting switch 31 and turning on the mode change-over switch 27 of the detection pixel, the state of the display element 11 appears on the detection line 20.

To detect the pixel of B, by turning on the B-selecting switch 32 and turning on the mode change-over switch 27 of the detection pixel, the state of the display element 11 appears on the detection line 20.

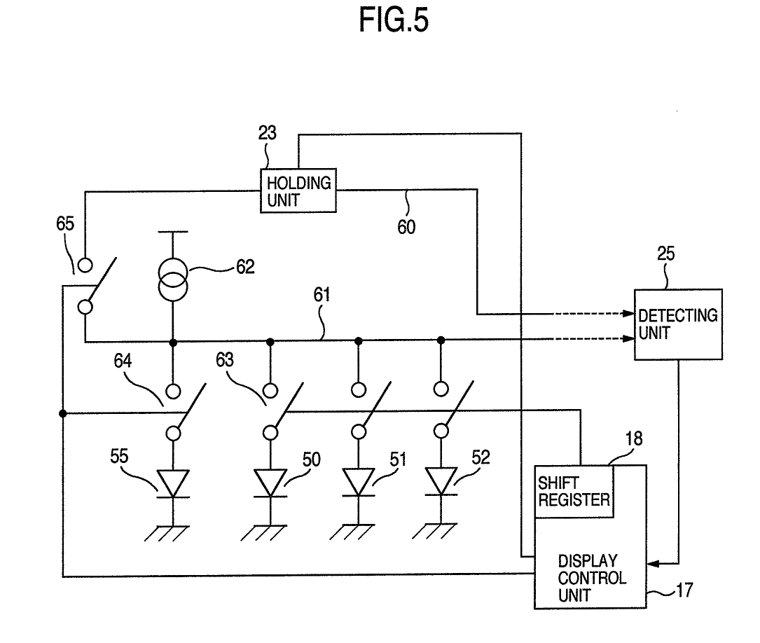

FIG. 5 shows a constructional example regarding a detection line and display elements. In this construction, a current source and a reference element are provided and the reference element and the display element are compared. In FIG. 5, the reference line 60 is connected to the holding unit 23 for holding the reference voltage. A current source 62 is connected to a detection line 61. Display elements 50, 51, and 52 and all of other display elements are connected to switches 63. A reference element 55 is connected to a switch 64. The holding unit 23 is connected to a switch 65. The switches 63, 64, and 65 are controlled by the display control unit 17.

Subsequently, the operation of FIG. 5 will be described. The display control unit 17 turns on the switches 64 and 65 and turns off all of the switches 63. In this state, the current source 62 and the reference element 55 are connected and the voltage in this instance is held in the holding unit 23. After that, under the control of the display control unit 17, the holding unit 23 holds this voltage value and continuously outputs this value to the reference line 60 until one detecting cycle is finished.

When the process of the reference element 55 is finished, the display control unit 17 connects the display element 50 to the detection line 61 by the switch 63 by using the shift register 18. The detecting unit 25 compares the voltages from the reference line 60 and the detection line 61 and outputs a comparison result to the display control unit 17. When the comparison result is inputted from the detecting unit 25, the display control unit 17 connects the display element 51 to the detection line 61 by the switch 63 by using the shift register 18. The detecting unit 25 compares the voltages from the reference line 60 and the detection line 61 and outputs a comparison result to the display control unit 17. In this manner, each display element is compared by using the reference element 55 as a reference.

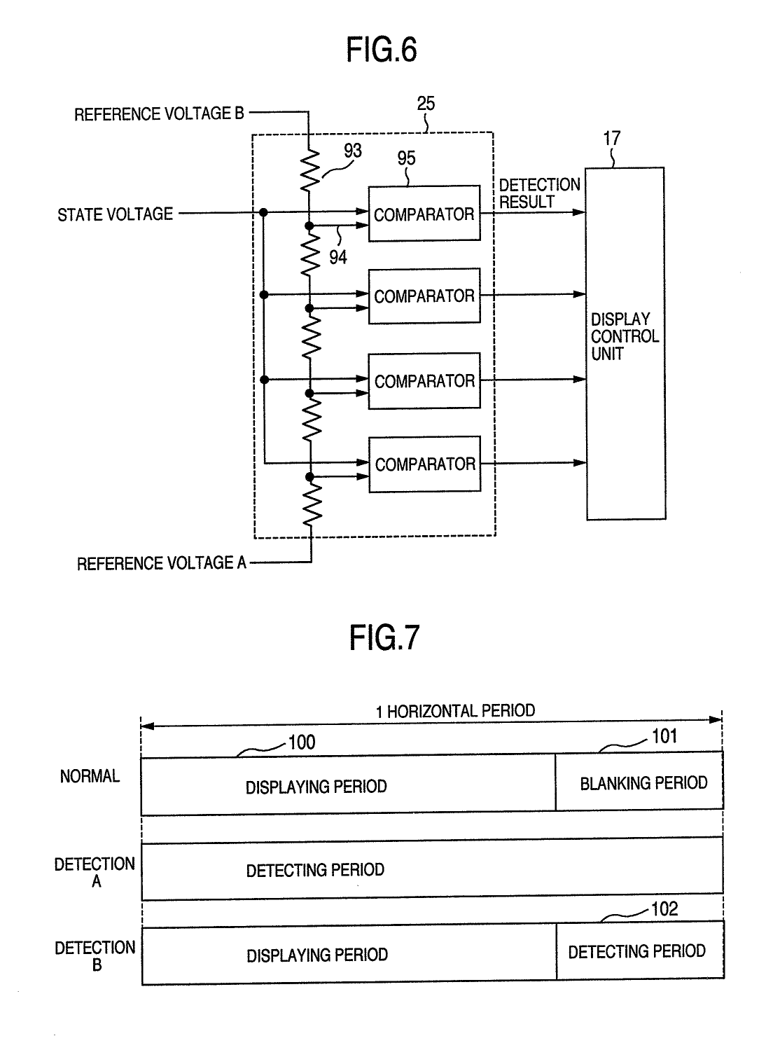

FIG. 6 shows a constructional example of the detecting unit 25 shown in FIG. 5. In FIG. 6, it is assumed that one of reference voltages A and B is equal to a value of the reference line 60 shown in FIG. 5 and the other is equal to a value obtained by adding or subtracting an offset value to/from the value of the reference line 60. Each of the reference voltages A and B is compared with the state voltage from the detection line 61 shown in FIG. 5. It is assumed that a reference value 94 which is used for the comparison is equal to a value obtained by dividing each of the reference voltages A and B by a resistance ladder 93. A comparator 95 compares the state voltage with the reference value 94 and outputs a comparison result to the display control unit 17.

Although there are four comparators 95 in the embodiment, the number of comparators and the division number of the resistance rudder 93 are determined while being increased or decreased according to comparing precision. The detection results obtained by the comparators 95 are processed in the display control unit 17 and the input display data is corrected and fed back to the display elements.

FIG. 7 shows detecting timing. In FIG. 7, ordinarily, there are a displaying period 100 and a blanking period 101 in one horizontal period. In a detection A, the whole displaying period 100 and the whole blanking period 101 are used for the detection and all pixels are detected. In this case, the display is not executed at all during the detection. In a detection B, the displaying period 100 is used as it is and all or a part of the blanking period 101 is allocated to a detecting period 102. In this case, since the detection is executed while displaying, it takes a longer time to detect the whole one display screen than that in the detection A. However, no influence is exercised on the displaying period.

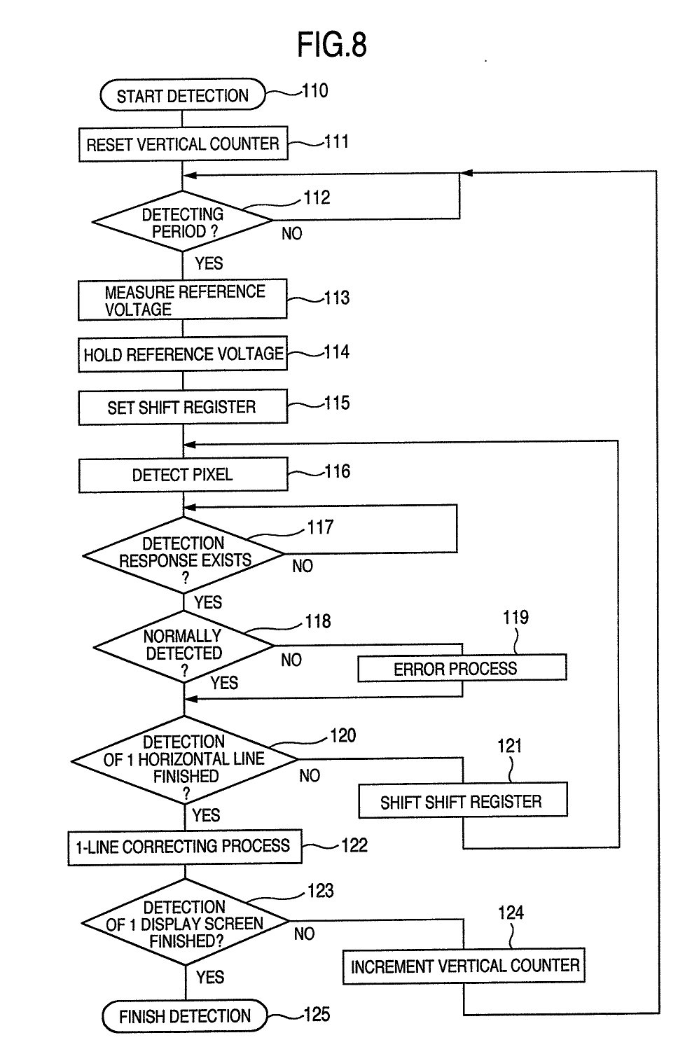

FIG. 8 is a flowchart showing processes in the display control unit. When the detecting process is started in a step 110, a vertical counter is reset in a step 111. Whether or not the period is the detecting period is discriminated in a step 112. In the detecting period, a reference voltage is measured in a step 113. The reference voltage indicative of a result of the step 113 is held in the holding unit in a step 114. The shift register to switch the pixels is set in a step 115. The state of the target pixel is detected in a step 116. The display control unit waits for a response from the detecting unit in a step 117. When the state of the target pixel is detected by the detecting unit, the detected state is discriminated in a step 118. If the state cannot be normally detected, an error process is executed in a step 119. If the state is normally detected in the step 118, whether or not the detection of one line has been finished is discriminated in a step 120. If the detection of the one line is being executed, the shift register is shifted in a step 121 and a remaining portion of the one line is detected. If the detection of the one line is finished in the step 120, a correcting process is executed in a step 122. Whether or not the detection of one display screen has been finished is discriminated in a step 123. If the detection of the one display screen is being executed, a vertical counter is counted up in a step 124 and a remaining portion of the one display screen is detected. If the detection of the one display screen is finished in the step 123, the detection is completed in a step 125.

### Embodiment 2

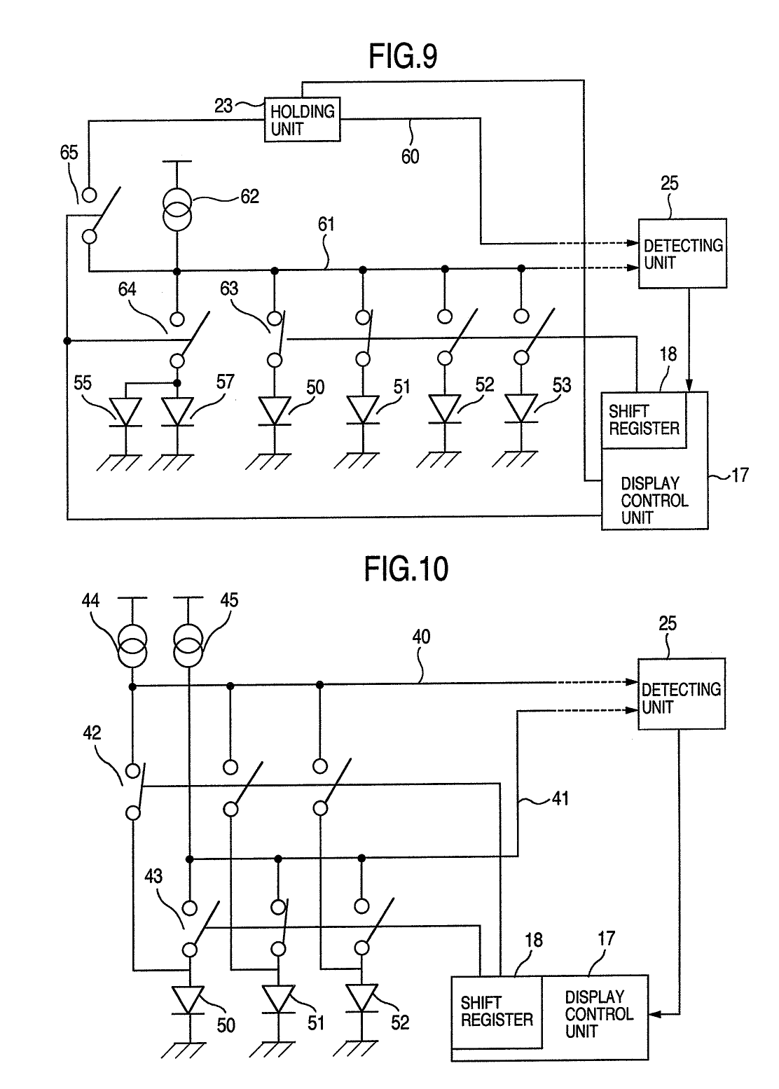

FIG. 9 shows an embodiment having another construction regarding FIG. 5 in the embodiment 1. According to this construction, a plurality of reference elements are detected in a lump. Assuming that n reference elements are provided, the number of display elements to be detected is equal to n. By increasing a current supply amount of the current source to n times, the detecting precision is increased to n times as compared with the case of detecting one reference element.

In FIG. 9, the reference line 60 is connected to the holding unit 23 for holding the reference voltage. The common current source 62 is connected to the detection line 61. The display elements (A 50, B 51, C 52), a display element D 53, and all of other pixels are connected by the switches 63. A reference element A 56 and a reference element B 57 are connected by the switch 64. The holding unit 23 is connected by the switch 65. The switches 63, 64, and 65 are controlled by the display control unit 17.

Subsequently, the operation of FIG. 9 will be described. The display control unit 17 turns on the switches 64 and 65 and turns off all of the switches 63. In this state, the current source 62 and the reference elements A 56 and B 57 are connected and the voltage in this instance is held in the holding unit 23. After that, under the control of the display control unit 17, the holding unit 23 holds this voltage value and continuously outputs this value to the reference line 60 until one detecting cycle is finished.

In the embodiment, since there are two reference elements, if characteristics of the reference elements are equal, the current of the current source 62 flows into the reference elements half-and-half. If the characteristics are different, average characteristics are derived. After completion of the processes of the reference elements, the display control unit 17 connects the display elements A 50 and B 51 to the detection line 61 by the switches 63 by using the shift register 18. A detection amount is equal to a mean amount of the pixels. The detecting unit 25 compares the voltages from the reference line 60 and the detection line 61 and outputs a comparison result to the display control unit 17. When the detection result is inputted from the detecting unit 25, the display control unit 17 connects the display elements C 52 and D 53 to the detection line 61 by the switches 63 by using the shift register 18. Subsequently, the detecting unit 25 compares the voltages from the reference line 60 and the detection line 61 and outputs a comparison result to the display control unit 17. In this manner, the comparison and detection in the case where a plurality of pixels are unified are executed.

### Embodiment 3

FIG. 10 shows an embodiment having another construction regarding FIG. 5 in the embodiment 1. According to this construction, no reference elements are provided besides the display elements, two current sources are provided, the adjacent display elements are compared, and a balance between the display elements is held. All of the display elements can be connected to a reference line 40 and a detection line 41 by a switch 42 and switches 43, respectively. As current sources, current sources 44 and 45 are independently provided for the reference line 40 and the detection line 41. The switches 42 and 43 are controlled by the display control unit 17.

Subsequently, the operation of FIG. 10 will be described. In the case of detecting the states of the display elements, the display elements A 50 and B 51 are compared and, subsequently, the display elements B 51 and C 52 are compared in this order. The display element A 50 is connected to the reference line 40 by the switch 42. The display element B 51 is connected to the detection line 41 by the switch 43. The detecting unit 25 compares voltages from the reference line 40 and the detection line 41 and outputs a comparison result to the display control unit 17. When the detection result is inputted from the detecting unit 25, the display control unit 17 connects the display element B 51 to the reference line 40 by the switch 42 and connects the display element C 52 to the detection line 41 by the switch 43. Subsequently, the detecting unit 25 compares the voltages from the reference line 40 and the detection line 41 and outputs a comparison result to the display control unit 17. In this manner, the adjacent display elements are compared. As a result of the comparison, the input display data to the display element having a difference is corrected.

### Embodiment 4

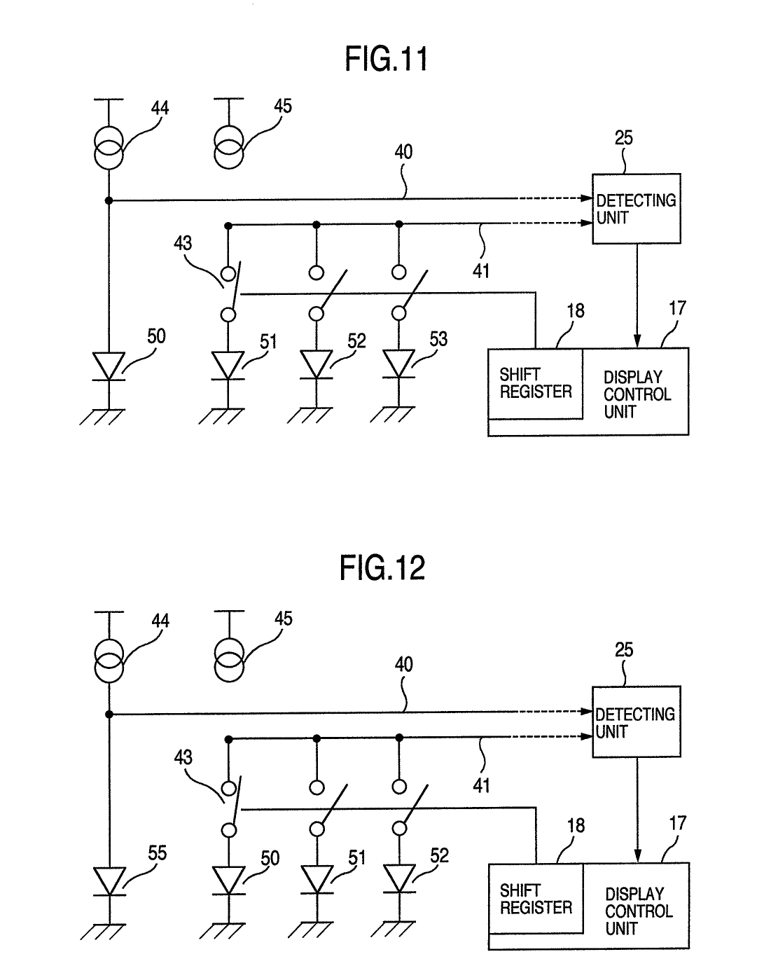

FIG. 11 shows an embodiment having another construction regarding FIG. 5 in the embodiment 1. According to this construction, no reference elements are provided besides the display elements, two current sources are provided, one of the display elements is set as a reference element, and other display elements are compared.

In FIG. 11, one of the display elements is connected as a representative to the reference line 40. The display element A 50 and the current source 44 are connected to the reference line 40. Although only one display element is connected to the reference line 40 in the embodiment, it is better to construct in such a manner that a plurality of display elements are selected by switches and can be connected to the reference line 40. The display elements B 51, C 52, and D 53 are connected to the detection line 41 by the switches 43. The current source 45 is connected to the detection line 41.

Subsequently, the operation of FIG. 11 will be described. In the case of detecting the states of the display elements, the display elements A 50 and B 51 are compared, the display elements A 50 and C 52 are compared, and subsequently, the display elements A 50 and D 53 are compared in this order. The display element A 50 is fixedly connected to the reference line 40 and the display element B 51 is connected to the detection line 41 by the switch 43. The detecting unit 25 compares the voltages from the reference line 40 and the detection line 41 and outputs a comparison result to the display control unit 17. When the detection result is inputted from the detecting unit 25, the display control unit 17 connects the display element C 52 to the detection line 41 by the switch 43. Subsequently, the detecting unit 25 compares the voltages from the reference line 40 and the detection line 41 and outputs a comparison result to the display control unit 17. In this manner, the other display elements are compared by using the display element A 50 as a reference.

### Embodiment 5

FIG. 12 shows an embodiment having another construction regarding FIG. 5 in the embodiment 1. According to this construction, two current sources are provided and the reference element and the display elements are compared. The reference element 55 and the current source 44 are connected to the reference line 40. Although only one reference element is connected to the reference line 40 in this embodiment, it is better to construct in such a manner that several reference elements are selected by switches and can be connected to the reference line 40. The display elements A 50, B 51 and C 52 are connected to the detection line 41 by the switches 43. The current source 45 is connected to the detection line 41.

Subsequently, the operation of FIG. 12 will be described. In the case of detecting the states of the reference element and the display elements, the reference element 55 and the display element A 50 are compared, the reference element 55 and the display element B 51 are compared, and subsequently, the reference element 55 and the display element C 52 are compared in this order. The reference element 55 is fixedly connected to the reference line 40 and the display element A 50 is connected to the detection line 41 by the switch 43. The detecting unit 25 compares the voltages from the reference line 40 and the detection line 41 and outputs a comparison result to the display control unit 17. When the detection result is inputted from the detecting unit 25, the display control unit 17 connects the display element B 51 to the detection line 41 by the switch 43. Subsequently, the detecting unit 25 compares the voltages from the reference line 40 and the detection line 41 and outputs a comparison result to the display control unit 17. In this manner, each display element is compared by using the reference element 55 as a reference.

### Embodiment 6

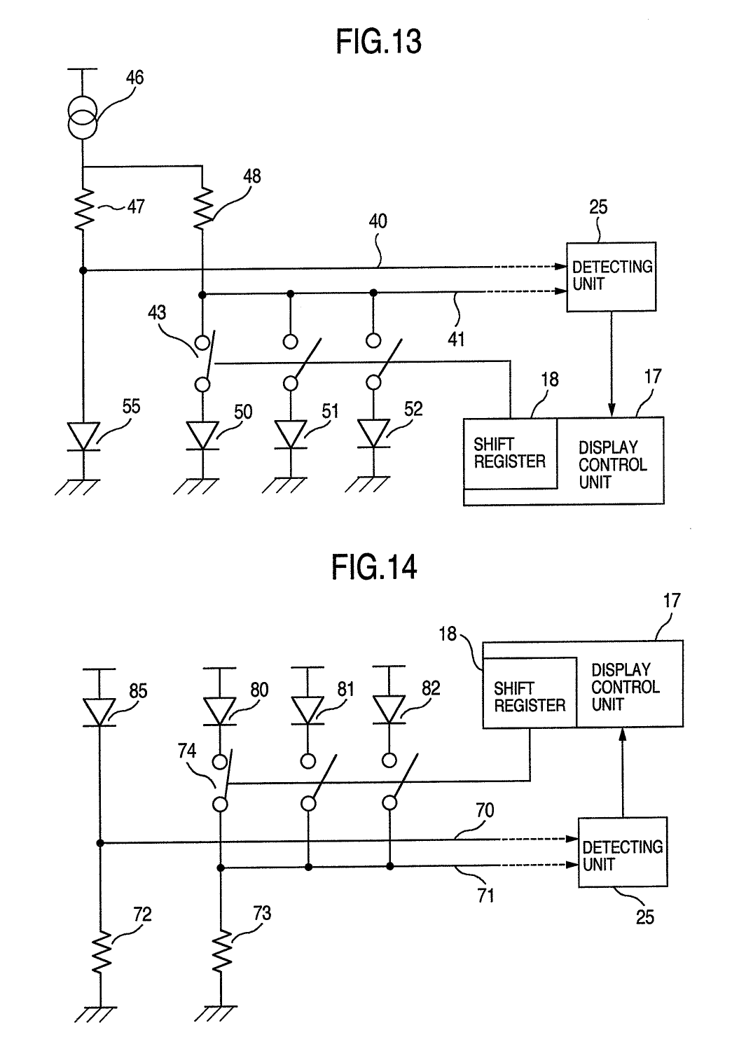

FIG. 13 shows an embodiment having another construction regarding FIG. 5 in the embodiment 1. According to this construction, a current source 46 is used in common for the reference line 40 through a resistor 47 and the detection line 41 through a resistor 48. The current source 46 is connected to the reference line 40 through the reference element 55 and the resistor 47.

Although only one reference element is connected to the reference line 40 in this embodiment, it is better to construct in such a manner that a plurality of reference elements are selected by switches and can be connected to the reference line 40. The display elements A 50, B 51 and C 52 are connected to the detection line 41 by the switches 43. The current source 46 is connected to the detection line 41 through the resistor 48.

Subsequently, the operation of FIG. 13 will be described. In the case of detecting the reference element and the display elements, the reference element 55 and the display element A 50 are compared, the reference element 55 and the display element B 51 are compared, and subsequently, the reference element 55 and the display element C 52 are compared in this order. The reference element 55 is fixedly connected to the reference line 40 and the display element A 50 is connected to the detection line 41 by the switch 43.

Since the current source 46 is used in common, if the reference element 55 and the display element A 50 are not equal, a small voltage difference occurs between the reference line 40 and the detection line 41. If the reference element 55 and the display element A 50 are equal, no voltage difference occurs between the reference line 40 and the detection line 41. The detecting unit 25 compares the voltages from the reference line 40 and the detection line 41 and outputs a comparison result to the display control unit 17. When the detection result is inputted from the detecting unit 25, the display control unit 17 connects the display element B 51 to the detection line 41 by the switch 43. Subsequently, the detecting unit 25 compares the voltages from the reference line 40 and the detection line 41 and outputs a comparison result to the display control unit 17. In this manner, each display element is compared by using the reference element 55 as a reference.

### Embodiment 7

FIG. 14 shows an embodiment having another construction regarding FIG. 5 in the embodiment 1. According to this construction, a voltage source is used in place of the current source. An anode of a reference element and anodes of display elements are connected to the voltage source. The reference element and the display elements are made operative by the voltage source and a constant resistor. A reference element 85 and a resistor 72 are connected to a reference line 70. A resistor 73 is connected to a detection line 71. Display elements A 80, B 81, and C 82 and all of other display elements are connected by switches 74. The switches 74 are controlled by the display control unit 17.

Subsequently, the operation of FIG. 14 will be described. On the reference line 70, a reference voltage appears at a connecting point of the reference element 85 and the resistor 72 which are serially connected to the voltage source. In the case of detecting the reference element and the display elements, the reference element 85 and the display element A 80 are compared, the reference element 85 and the display element B 81 are compared, and subsequently, the reference element 85 and the display element C 82 are compared in this order. The display element A 80 is connected to the detection line 71 by the switch 74 by using the display control unit 17. The detecting unit 25 compares voltages from the reference line 70 and the detection line 71 and outputs a comparison result to the display control unit 17. When the detection result is inputted from the detecting unit 25, the display control unit 17 connects the display element B 81 to the detection line 71 by the switch 74. Subsequently, the detecting unit 25 compares the voltages from the reference line 70 and the detection line 71 and outputs a comparison result to the display control unit 17. In this manner, each display element is compared by using the reference element 85 as a reference.

It should be further understood by those skilled in the art that although the foregoing description has been made on embodiments of the invention, the invention is not limited thereto and various changes and modifications may be made without departing from the spirit of the invention and the scope of the appended claims.

1. A display device comprising:
a plurality of display elements;
a pixel control unit for controlling light emission amounts of said display elements in accordance with display data;
a displaying power source connected to said pixel control unit;
a signal line for inputting the display data to said display elements and outputting states of said display elements;
a detecting switch for switching the input of the display data to said signal line and the output of the states of the display elements;
a detecting power source connected to said detecting switch; and
a detecting unit for detecting the states of the display elements from said detecting switch,
wherein the states of said display elements are inputted to said detecting unit through said signal line and said detecting switch.

2. A device according to claim 1, wherein said detecting power source is a current source and said displaying power source is a voltage source.

3. A device according to claim 1, wherein said detecting unit holds a state of a reference element provided separately from said display elements and compares the state of said reference element with the states of said display elements.

4. A device according to claim 1, wherein said detecting unit holds states of a plurality of reference elements provided separately from said display elements and compares states of said reference elements with the states of said plurality of display elements.

5. A device according to claim 1, wherein said detecting unit compares states of the adjacent display elements.

6. A device according to claim 1, wherein said detecting unit compares the state of the display element selected as a reference element from said plurality of display elements with the states of the other display elements.

7. A device according to claim 1, wherein said detecting unit compares a state of a reference element provided separately from said display elements with the states of said display elements.

8. A device according to claim 5, wherein two current sources are connected as said detecting power source to said detecting unit.

9. A device according to claim 5, wherein two parallel resistors connected serially to said detecting power source are connected to said detecting unit.

10. A device according to claim 1, wherein a resistor which operates by a voltage source as said detecting power source is connected to said detecting unit.

11. A device according to claim 1, wherein said detecting unit is constructed by a plurality of comparators connected to a resistance rudder.

12. A device according to claim 1, further comprising a display control unit for correcting the display data on the basis of a detection result of said detecting unit.

13. A device according to claim 3, wherein said detecting power source is provided in common to said reference element and all of the display elements as detection targets.

14. A display device comprising:
a plurality of display elements;
a display control unit for transmitting a signal according to display data to said display elements through a signal line;
a voltage source which is common to said plurality of display elements;
a current source which is common to said plurality of display elements;
a detecting unit for detecting voltages of said display elements through said signal line; and
a control unit for controlling in such a manner that, for a first period of time, said voltage source and said display elements are connected, an output of the signal according to said display data of said display control unit and said display elements are connected, and said current source and said display elements are disconnected, and for a second period of time, said voltage source and said display elements are disconnected, the output of the signal according to said display data of said display control unit and said display elements are disconnected, and said current source and said display elements are connected,
wherein said current source is common to said display elements and a reference element serving as a reference of the detection,
for said first period of time, said display control unit transmits the signal according to said display data to said display elements through said signal line;
for said first period of time, said display elements emit light in accordance with the signal according to said display data and a voltage from said voltage source, and
for said second period of time, said detecting unit inputs the voltages of said display elements through said signal line and inputs the voltages of said reference elements.

15. A device according to claim 6, wherein two current sources are connected as said detecting power source to said detecting unit.

16. A device according to claim 7, wherein two current sources are connected as said detecting power source to said detecting unit.

17. A device according to claim 6, wherein two parallel resistors connected serially to said detecting power source are connected to said detecting unit.

18. A device according to claim 7, wherein two parallel resistors connected serially to said detecting power source are connected to said detecting unit.
